(19) United States
(12) Patent Application Publication
(10) Pub. No.: US 2015/0030472 A1
(43) Pub. Date: Jan. 29, 2015

(54) HYDRAULIC PRESSURE SUPPLY SYSTEM OF AUTOMATIC TRANSMISSION FOR VEHICLE

(71) Applicant: Hyundai Motor Company, Seoul (KR)

(72) Inventor: Taehwan WI, Bucheon-si (KR)

(73) Assignee: Hyundai Motor Company, Seoul (KR)

(21) Appl. No.: 14/145,543

(22) Filed: Dec. 31, 2013

(30) Foreign Application Priority Data
Jul. 29, 2013 (KR) 10-2013-0089489

(51) Int. Cl. F16H 61/4017

(52) U.S. Cl. CPC F16H 61/4017
USPC 417/286

(57) ABSTRACT

A hydraulic pressure supply system of an automatic transmission for a vehicle may be provided with first and second pump chambers and may supply hydraulic pressure generated at the first and second pump chambers selectively to a high pressure portion or the high pressure portion and a low pressure portion. The hydraulic pressure generated at the first pump chamber may be supplied to the high pressure portion through a high-pressure regulator valve, and the hydraulic pressure generated at the second pump chamber may be supplied to the low pressure portion through a low-pressure regulator valve or may be supplied to the high-pressure regulator valve according to switching operation of a switch valve.

### CROSS-REFERENCE TO RELATED APPLICATION

The present application claims priority of Korean Patent Application Number 10-2013-0089489 filed Jul. 29, 2013, the entire contents of which application is incorporated herein for all purposes by this reference.

### BACKGROUND OF INVENTION

1. Field of Invention

The present invention relates to a hydraulic pressure supply system of an automatic transmission for a vehicle. More particularly, the present invention relates to a hydraulic pressure supply system of an automatic transmission for a vehicle which increases oil amount of a low pressure portion by supplying recirculated hydraulic pressure to the low pressure portion at a half discharge mode and improves fuel economy by reducing hydraulic pressure of the low pressure portion according to hydraulic pressure of a high pressure portion and lowering rotation speed for entering the half discharge mode.

2. Description of Related Art

A gear pump is mainly used as a hydraulic pump applied to a hydraulic pressure supply system of an automatic transmission for a vehicle. However, a vane pump that can supply sufficient oil at a low speed region is recently used.

The vane pump increases discharge amount in proportion to a rotation speed thereof. If the vane pump is controlled to supply the sufficient oil at the low speed region, unnecessarily much oil is supplied and thereby causes driving loss of the pump at a high speed region.

Therefore, the vane pump includes first and second pump chambers disposed on a shaft of a rotor so as to recirculate surplus oil at the high speed region.

The first pump chamber is a main pump chamber, and hydraulic pressure generated at the first pump chamber is supplied to a shifting portion (friction members, a torque converter, a cooling device, a lubrication device and so on).

The second pump chamber is a pump chamber, and hydraulic pressure generated at the second pump chamber is supplied to the shifting portion or is recirculated.

In further detail, the hydraulic pressure generated at the first pump chamber and the second pump chamber is supplied to the shifting portion if an engine speed is low, but the hydraulic pressure generated at the second pump chamber is recirculated to an inlet side if the engine speed is high. Therefore, driving loss of the pump may be minimized and fuel economy may be enhanced.

FIG. 1 is a schematic diagram of a conventional hydraulic pressure supply system of an automatic transmission for a vehicle with a vane pump and illustrates oil flow at a full discharge mode.

Referring to FIG. 1, a vane pump includes a first pump chamber 4 and a second pump chamber 6 formed therein. The first pump chamber 4 and the second pump chamber 6 are formed symmetrically with respect to a rotor 2 in an axial direction.

The first pump chamber 4 is connected to a first input port 4a and a first discharge port 4b, and the second pump chamber 6 is connected to a second input port 6a and a second discharge port 6b. The first and second input ports 4a and 6a are connected to an oil pan 8 respectively through first and second input lines 4c and 6c, and the first and second discharge ports 6b and 6b are connected to a shifting portion 10 respectively through first and second discharge lines 4d and 6d.

In addition, a switch valve 12 controlled by a solenoid valve SOL is disposed on the second discharge line 6d.

The switch valve 12 selectively cuts off the second discharge line 6d. If the second discharge line 6d is cut off, the second discharge line 6d is connected to a recirculation line 14.

As shown in FIG. 1, hydraulic pressure generated at the first and second pump chambers 4 and 6 is supplied to the shifting portion 10 through the first and second discharge lines 4d and 6d at a low speed region.

FIG. 2 is a schematic diagram of a conventional hydraulic pressure supply system of an automatic transmission for a vehicle with a vane pump and illustrates oil flow at a half discharge mode.

Referring to FIG. 2, the solenoid valve SOL controls the switch valve 12 to cut off the second discharge line 6d at a high speed region.

In this case, the hydraulic pressure generated at the second pump chamber 6 is recirculated through the switch valve 12 and the recirculation line 14. Therefore, the hydraulic pressure generated only at the first pump chamber 4 is supplied to the shifting portion 10. Therefore, pump loss due to generation of excess hydraulic pressure may be reduced.

Since oil amount required at a transmission should be satisfied by the hydraulic pressure generated only at the first pump chamber 4 at the half discharge mode according to the conventional hydraulic pressure supply system, the vane pump should be operated with rotation speed higher than a predetermined rotation speed. In addition, if oil temperature rises, the oil amount required at the transmission is further increased. Therefore, rotation speed for entering the half discharge mode also rises.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention have been made in an effort to provide a hydraulic pressure supply system of an automatic transmission for a vehicle having advantages of increasing oil amount of a low pressure portion by supplying recirculated hydraulic pressure to the low pressure portion at a half discharge mode and improving fuel economy by lowering rotation speed for entering the half discharge mode.

Various aspects of the present invention provide for hydraulic pressure supply system of an automatic transmission for a vehicle that may include: a hydraulic pump provided with first and second pump chambers formed therein and discharging hydraulic pressure generated at the first and second pump chambers; a high-pressure line supplying the hydraulic pressure discharged from the first pump chamber to a high pressure portion; a switch valve supplying the hydraulic pressure discharged from the second pump chamber selectively to the high-pressure line or a first low-pressure line; a low-pressure regulator valve regulating the hydraulic pressure supplied from the first low-pressure line to be stable and supplying the regulated hydraulic pressure to a low pressure portion through a second low-pressure line; a high-pressure regulator valve regulating the hydraulic pressure supplied to the high-pressure line to be stable and supplying the regulated hydraulic pressure to the high pressure portion; and a first recirculation line supplying recirculated hydraulic pressure of the high-pressure regulator valve to the low pressure portion.

The high-pressure regulator valve may be controlled by control pressure of a solenoid valve and elastic force of an elastic member counteracting against the control pressure.

The switch valve may be controlled by the recirculated hydraulic pressure of the high-pressure regulator valve supplied through a second recirculation line bifurcated from the first recirculation line and elastic force of an elastic member counteracting against the recirculated hydraulic pressure.

An orifice may be disposed on the first recirculation line downstream of a bifurcating point of the second recirculation line.

The switch valve may be controlled by the control pressure of the solenoid valve controlling the high-pressure regulator valve and elastic force of an elastic member counteracting against the control pressure.

A portion of the hydraulic pressure of the low-pressure regulator valve may be recirculated to the first and second pump chambers through a third recirculation line.

The switch valve may be controlled by hydraulic pressure of a control pressure line bifurcated from the third recirculation line and elastic force of an elastic member counteracting against the hydraulic pressure.

An orifice may be mounted on the third recirculation line downstream of the bifurcating point of the control pressure line.

The first recirculation line may be connected to a low-pressure line between the switch valve and the low-pressure regulator valve.

The hydraulic pressure supply system may further include a bypass line connecting the first recirculation line downstream of the orifice with the high-pressure regulator valve.

The first recirculation line may be connected to a low-pressure line between the low-pressure regulator valve and the low pressure portion.

Various aspects of the present invention provide for a hydraulic pressure supply system of an automatic transmission for a vehicle that may be provided with first and second pump chambers and may supply hydraulic pressure generated at the first and second pump chambers selectively to a high pressure portion or the high pressure portion and a low pressure portion.

The hydraulic pressure generated at the first pump chamber may be supplied to the high pressure portion through a high-pressure regulator valve, and the hydraulic pressure generated at the second pump chamber may be supplied to the low pressure portion through a low-pressure regulator valve or may be supplied to the high-pressure regulator valve according to switching operation of a switch valve.

Recirculated hydraulic pressure of the high-pressure regulator valve may be additionally supplied to the low pressure portion.

A portion of the recirculated hydraulic pressure of the high-pressure regulator valve may be reduced by an orifice and is then supplied to the low pressure portion.

A portion of the recirculated hydraulic pressure of the high-pressure regulator valve may be supplied to the switch valve as control pressure.

The high-pressure regulator valve may be controlled by control pressure of a solenoid valve.

The switch valve may be controlled by the control pressure of the solenoid valve.

Recirculated hydraulic pressure of the low-pressure regulator valve may be recirculated to the first and second pump chambers.

A portion of the recirculated hydraulic pressure of the low-pressure regulator valve may be supplied to the switch valve as control pressure.

The recirculated hydraulic pressure of the high-pressure regulator valve may be supplied between the switch valve and the low-pressure regulator valve.

The recirculated hydraulic pressure of the high-pressure regulator valve may be supplied between the low-pressure regulator valve and the low pressure portion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a conventional hydraulic pressure supply system of an automatic transmission for a vehicle with a vane pump and illustrates oil flow at a full discharge mode.

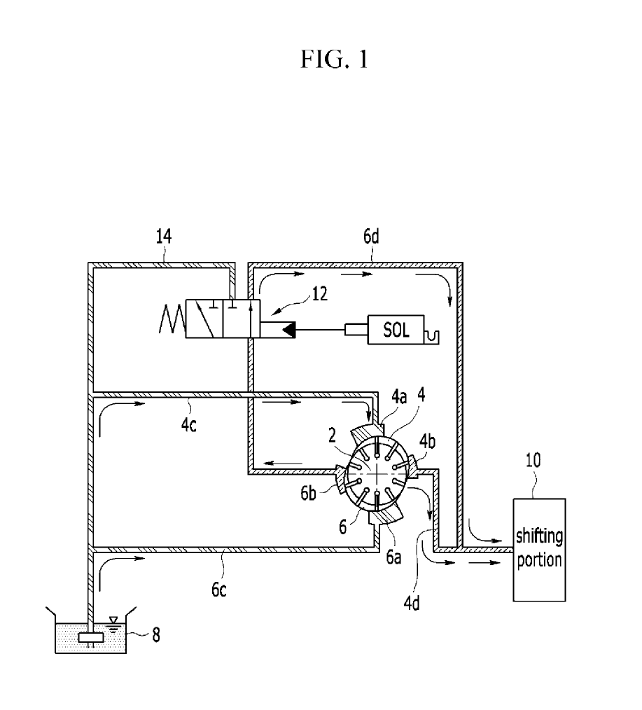

FIG. 2 is a schematic diagram of a conventional hydraulic pressure supply system of an automatic transmission for a vehicle with a vane pump and illustrates oil flow at a half discharge mode.

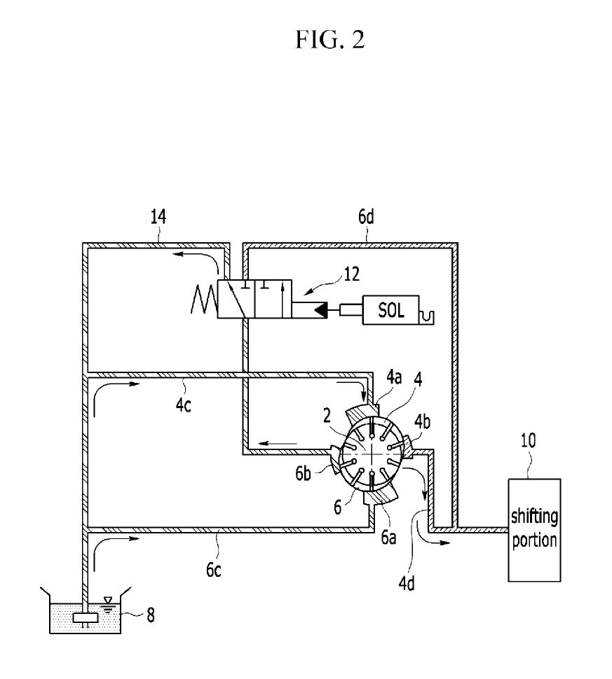

FIG. 3 is a schematic diagram of an exemplary hydraulic pressure supply system according to the present invention and illustrates oil flow at a full discharge mode.

FIG. 4 is a schematic diagram of an exemplary hydraulic pressure supply system according to the present invention and illustrates oil flow at a half discharge mode.

FIG. 5 is a schematic diagram of an exemplary hydraulic pressure supply system according to the present invention and illustrates oil flow at a full discharge mode.

FIG. 6 is a schematic diagram of an exemplary hydraulic pressure supply system according to the present invention and illustrates oil flow at a half discharge mode.

FIG. 7 is a schematic diagram of an exemplary hydraulic pressure supply system according to the present invention and illustrates oil flow at a full discharge mode.

FIG. 8 is a schematic diagram of an exemplary hydraulic pressure supply system according to the present invention and illustrates oil flow at a half discharge mode.

FIG. 9 is a schematic diagram of an exemplary hydraulic pressure supply system according to the present invention and illustrates oil flow at a full discharge mode.

FIG. 10 is a schematic diagram of an exemplary hydraulic pressure supply system according to the present invention and illustrates oil flow at a half discharge mode.

FIG. 11 is a schematic diagram of an exemplary hydraulic pressure supply system according to the present invention and illustrates oil flow at a full discharge mode.

FIG. 12 is a schematic diagram of an exemplary hydraulic pressure supply system according to the present invention and illustrates oil flow at a half discharge mode.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the various embodiments will be omitted, and the same constituent elements are denoted by the same reference numerals in this specification.

In the detailed description, ordinal numbers are used for distinguishing constituent elements having the same terms, and have no specific meanings.

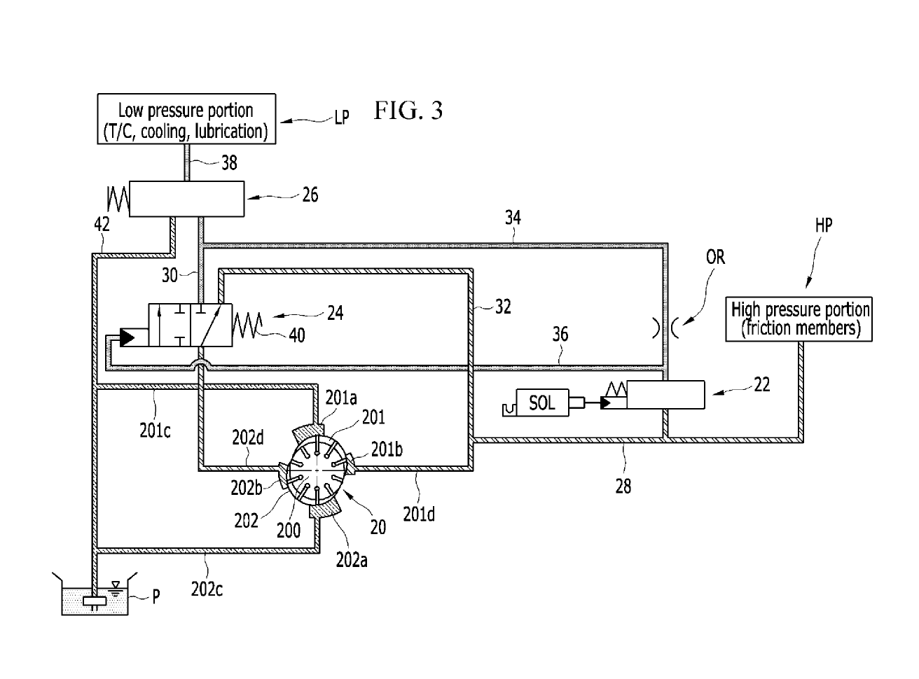

FIG. 3 is a schematic diagram of a hydraulic pressure supply system according to the various embodiments of the present invention and illustrates oil flow at a full discharge mode.

Referring to FIG. 3, a hydraulic pressure supply system according to various embodiments of the present invention includes a low pressure portion LP and a high pressure portion HP. Therefore, hydraulic pressure generated at a hydraulic pump 20 is supplied simultaneously to the low pressure portion LP and the high pressure portion HP or only to the high pressure portion HP.

The low pressure portion LP represents a portion to which a low pressure facilitating operation of the torque converter (T/C) and cooling and lubrication is supplied, and the high pressure portion HP represents a portion to which a high pressure facilitating operation of a plurality of friction members that is selectively operated when shifting or a pulley (e.g., pulley for a CVT) is supplied.

The hydraulic pressure supply system according to various embodiments of the present invention including the low pressure portion LP and the high pressure portion HP includes a hydraulic pump 20, a high-pressure regulator valve 22, a switch valve 24, and a low-pressure regulator valve 26.

The hydraulic pump 20 is a vane pump and includes a first pump chamber 201 and a second pump chamber 202 formed therein. The first pump chamber 201 and the second pump chamber 202 are formed symmetrically with respect to a rotor 200 in an axial direction. The first pump chamber 201 is connected to a first input port 201a and a first discharge port 201b, and the second pump chamber 202 is connected to a second input port 202a and a second discharge port 202b.

The first and second input ports 201a and 202a are connected to an oil pan P respectively though first and second input lines 201c and 202c, and the first and second discharge ports 201b and 202b are connected respectively to first and second discharge lines 201d and 202d.

The first discharge line 201d is connected to the high pressure portion HP through a high-pressure line 28, and the second discharge line 202d is connected to a first low-pressure line 30 through a switch valve 24 or is connected to a circulation line 32 selectively.

The high-pressure regulator valve 22 is controlled by a solenoid valve SOL so as to regulate hydraulic pressure supplied to the high pressure portion HP to be stable, and recirculated hydraulic pressure generated at regulating process is recirculated through first and second recirculation lines 34 and 36.

The first recirculation line 34 is connected to the first low-pressure line 30 so as to supply the recirculated hydraulic pressure of the high-pressure regulator valve 22 to the low pressure portion LP. Therefore, oil amount of the low pressure portion LP may be increased. An orifice OR is mounted on the first recirculation line 34.

The second recirculation line 36 is bifurcated from the first recirculation line 34 between the orifice OR and the high-pressure regulator valve 22, and is connected to the switch valve 24 so as to supply the recirculated hydraulic pressure of the high-pressure regulator valve 22 to the switch valve 24 as control pressure.

At this time, the hydraulic pressure of the first recirculation line 34 supplied to the first low-pressure line 30 is lower than that of the second recirculation line 36 by the orifice OR.

The switch valve 24 is controlled by the hydraulic pressure of the second recirculation line 36 and elastic force of an elastic member 40 counteracting against the hydraulic pressure so as to connect the second discharge line 202d selectively to the first low-pressure line 30 or the circulation line 32.

The low-pressure regulator valve 24 regulates the hydraulic pressure supplied from the first low-pressure line 30 to be stable, supplies the regulated hydraulic pressure to the low pressure portion LP through a second low-pressure line 38, and recirculates recirculated hydraulic pressure generated at a regulating process to the first and second input lines 201c and 202c through a third recirculation line 42.

In the hydraulic pressure supply system according to various embodiments of the present invention, as shown in FIG. 3, the switch valve 24 is controlled by elastic force of the elastic member 40 so as to connect the second discharge line 202d with the circulation line 32 at a full discharge mode.

Therefore, the hydraulic pressure generated at the first and second pump chambers 201 and 202 is supplied to the high pressure portion HP through the first and second discharge line 201d and 202d and the high-pressure line 28.

At this time, since the recirculated hydraulic pressure of the high-pressure regulator valve 22 is low, the switch valve 24 continues to connect the second discharge line 202d with the circulation line 32.

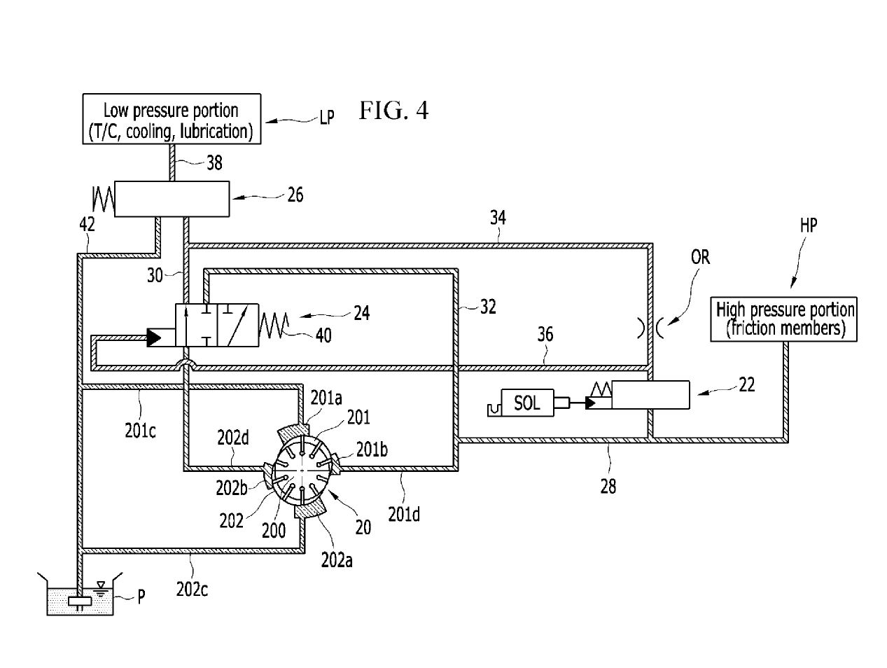

FIG. 4 is a schematic diagram of a hydraulic pressure supply system according to various embodiments of the present invention and illustrates oil flow at a half discharge mode.

Referring to FIG. 4, since the recirculated hydraulic pressure of the high-pressure regulator valve 22 is high, the control pressure of the switch valve 24 supplied through the second recirculation line 36 overcomes the elastic force of the elastic member 40 at a half discharge mode.

In this case, the switch valve 24 connects the second discharge line 202d with the first low-pressure line 30. Therefore, the hydraulic pressure generated at the first pump chamber 201 is supplied to the high pressure portion HP through the first discharge line 201d and the high-pressure line 28, and the hydraulic pressure generated at the second pump chamber 202 is supplied to the low-pressure regulator valve 24 through the second discharge line 202d, the switch valve 24, and the first low-pressure line 30. The hydraulic pressure supplied to the low-pressure regulator valve 24 is supplied to the low pressure portion LP through the second low-pressure line 38.

The hydraulic pressure supply system according to various embodiments of the present invention supplies the hydraulic pressure generated at the first and second pump chambers 201 and 202 of the hydraulic pump 20 entirely to the high pressure portion HP at the full discharge mode, and supplies the hydraulic pressure generated at the first pump chamber 201 to the high pressure portion HP and the hydraulic pressure generated at the second pump chamber 202 to the low pressure portion LP at the half discharge mode.

Therefore, oil amount supplied to the low pressure portion LP is increased at the half discharge mode. Since oil amount required at the high pressure portion HP is reduced, rotation speed for entering the half discharge mode is reduced and fuel economy may be enhanced.

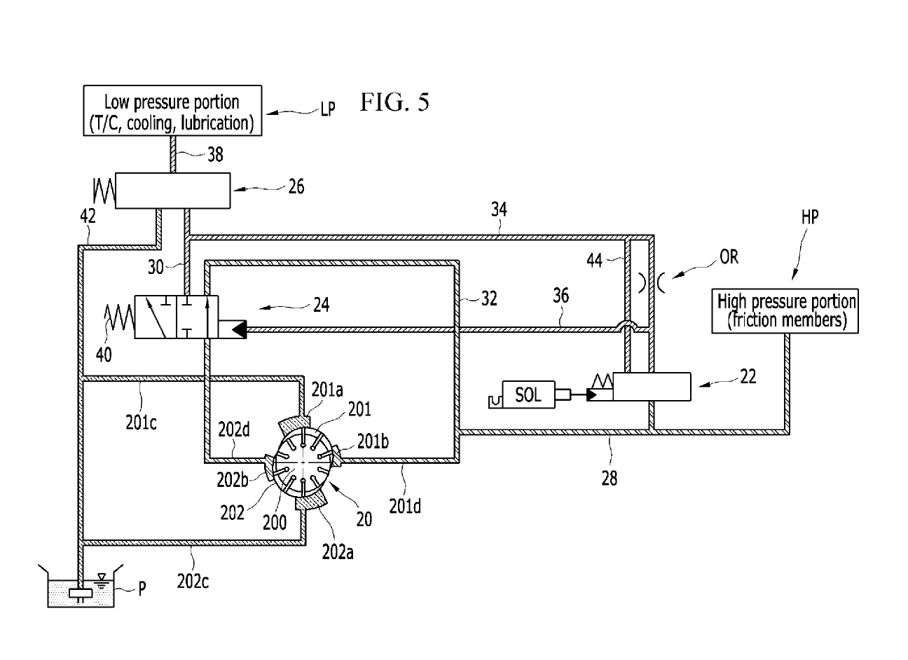

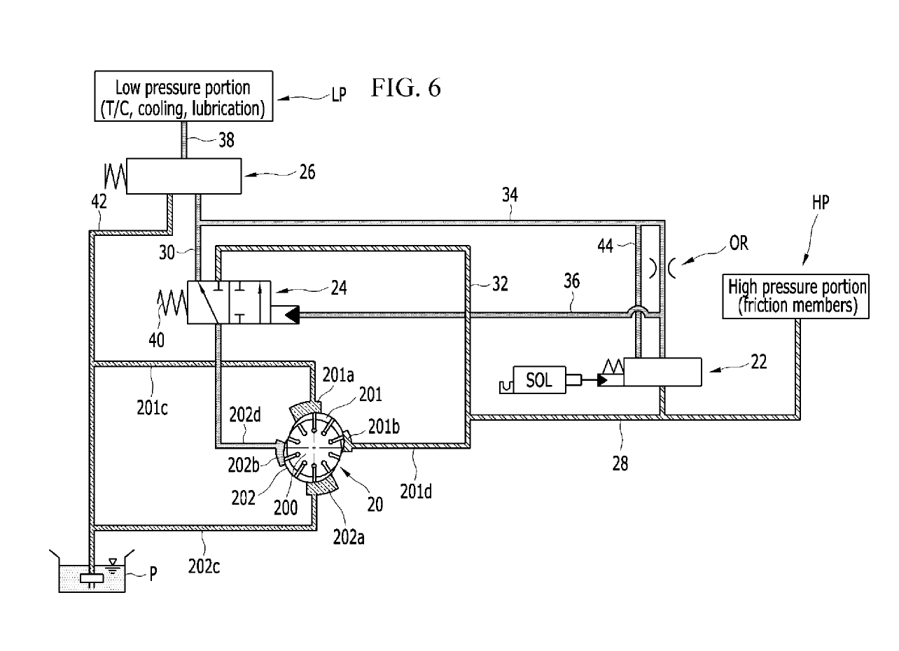

FIG. 5 and FIG. 6 are schematic diagram of a hydraulic pressure supply system according to various embodiments of the present invention. FIG. 5 illustrates oil flow at a full discharge mode, and FIG. 6 illustrates oil flow at a half discharge mode.

Referring to FIG. 5 and FIG. 6, a downstream end of the first recirculation line 34 is connected to the first low-pressure line 30 in the above-described embodiment, but a bypass line 44 connecting the high-pressure regulator valve 22 with a downstream of the orifice OR on the first recirculation line 34 is further included in various embodiments.

As shown in FIG. 5, since the control pressure of the switch valve 24 is lower than the hydraulic pressure of the second recirculation line 36, the second discharge line 202d and the circulation line 32 are connected by the elastic force of the elastic member 40 at the full discharge mode.

In this case, the hydraulic pressure generated at the first and second pump chambers 201 and 202 is supplied to the high pressure portion HP through the first and second discharge lines 201d 202d and the high-pressure line 28.

As shown in FIG. 6, since the recirculated hydraulic pressure of the high-pressure regulator valve 22 is high, the recirculated hydraulic pressure is supplied to the switch valve 24 as the control pressure through the second recirculation line 36 and is supplied to the first low-pressure line 30 through the first recirculation line 34 at the half discharge mode.

At this time, since the recirculated hydraulic pressure passing through the bypass line 44 is joined to the downstream of the first recirculation line 34, more oil can be supplied to the low pressure portion LP.

In addition, the switch valve 24 connects the second discharge line 202d with the first low-pressure line 30 by the recirculated hydraulic pressure supplied through the second recirculation line 36. Therefore, the hydraulic pressure generated at the first pump chamber 201 is supplied to the high pressure portion HP through the first discharge line 201d and the high-pressure line 28, and the hydraulic pressure generated at the second pump chamber 202 is supplied to the low-pressure regulator valve 24 through the second discharge line 202d, the switch valve 24, and the first low-pressure line 30. The hydraulic pressure supplied to the low-pressure regulator valve 24 is supplied to the low pressure portion LP through the second low-pressure line 38.

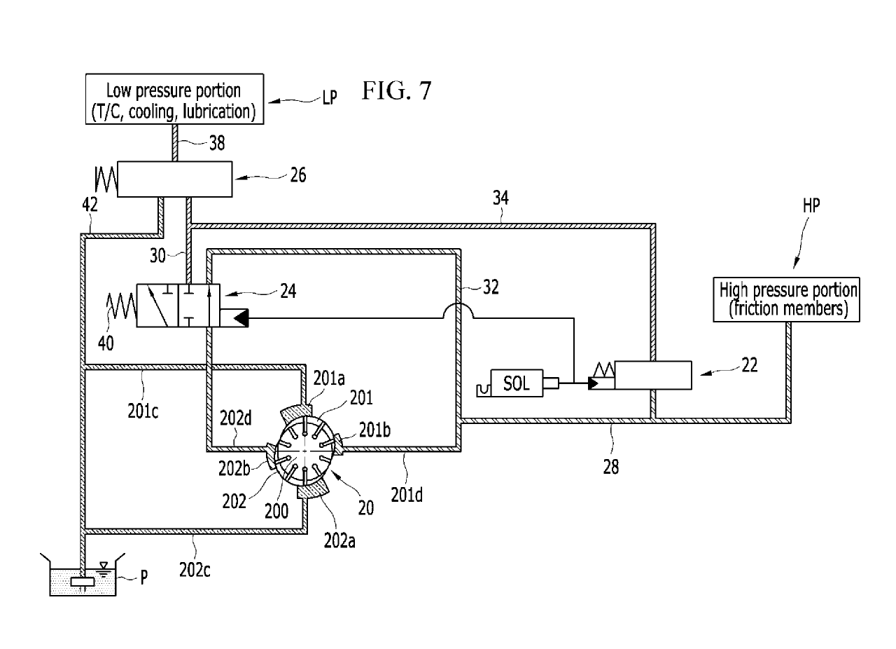

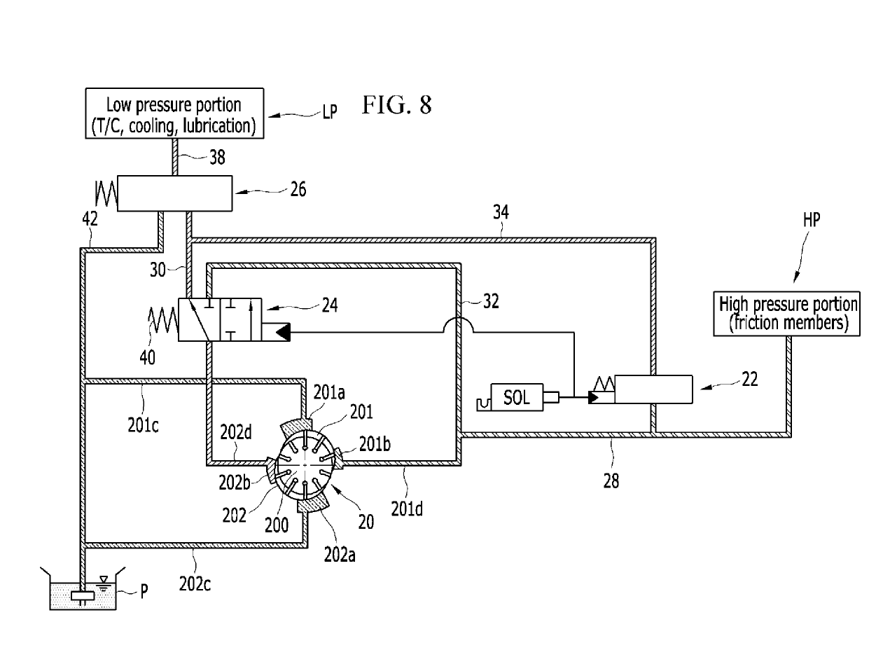

FIG. 7 and FIG. 8 are schematic diagram of a hydraulic pressure supply system according to various embodiments of the present invention. FIG. 7 illustrates oil flow at a full discharge mode, and FIG. 8 illustrates oil flow at a half discharge mode.

Referring to FIG. 7 and FIG. 8, the recirculated hydraulic pressure of the high-pressure regulator valve 22 is used as the control pressure of the switch valve 24 in an above-described embodiment, but the control pressure of the solenoid valve SOL controlling the high-pressure regulator valve 22 is used as the control pressure of the switch valve 24 in various embodiments.

Compared with system of FIG. 3, the second recirculation line 36 is removed, the orifice OR of the first recirculation line 36 is also removed, and the recirculated hydraulic pressure of the high-pressure regulator valve 22 is supplied entirely to the first low-pressure line 30 in the system shown in FIG. 7.

As shown in FIG. 7, since the control pressure of the solenoid valve SOL is supplied to the switch valve 24, the switch valve 24 connects the second discharge line 202d with the circulation line 32 at the full discharge mode.

In this case, the hydraulic pressure generated at the first and second pump chambers 201 and 202 is supplied entirely to the high pressure portion HP through the first and second discharge lines 201d and 202d and the high-pressure line 28.

As shown in FIG. 8, since the control pressure supplied from the solenoid valve SOL is low, the switch valve 24 connects the second discharge line 202d with the first low-pressure line 30 by the elastic force of the elastic member 40 at the half discharge mode.

Therefore, the hydraulic pressure generated at the first pump chamber 201 is supplied to the high pressure portion HP through the first discharge line 201d and the high-pressure line 28, and the hydraulic pressure generated at the second pump chamber 202 is supplied to the low-pressure regulator valve 24 through the second discharge line 202d, the switch valve 24, and the first low-pressure line 30. The hydraulic pressure supplied to the low-pressure regulator valve 24 is supplied to the low pressure portion LP through the second low-pressure line 38.

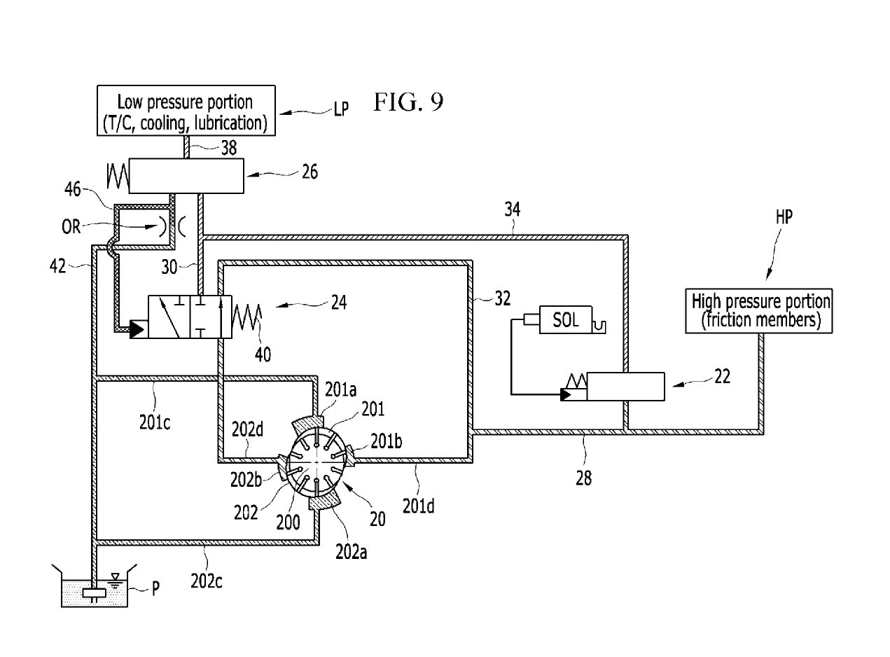

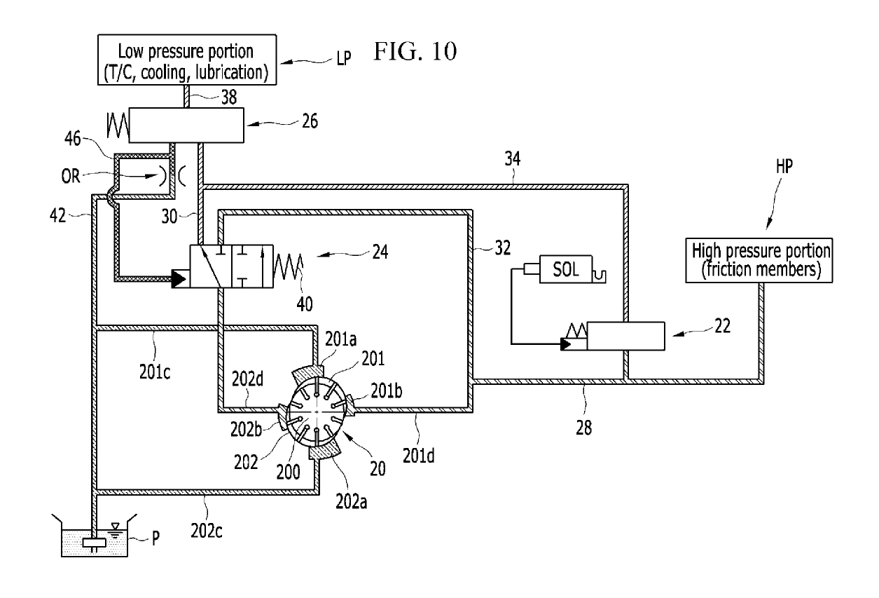

FIG. 9 and FIG. 10 are schematic diagram of a hydraulic pressure supply system according to various embodiments of the present invention. FIG. 9 illustrates oil flow at a full discharge mode, and FIG. 10 illustrates oil flow at a half discharge mode.

Referring to FIG. 9 and FIG. 10, the recirculated hydraulic pressure of the high-pressure regulator valve 22 is used as the control pressure of the switch valve 24 in an above-described embodiment, but the recirculated hydraulic pressure of the low-pressure regulator valve 26 is used as the control pressure of the switch valve 24 in various embodiments.

For this purpose, an orifice OR is disposed on the third recirculation line 42, and the control pressure line 46 is bifurcated from the third recirculation line 42 upstream of the orifice OR. The control pressure line 46 supplies the hydraulic pressure of the third recirculation line 42 to the switch valve 24 as the control pressure.

Compared with system of FIG. 3, the second recirculation line 36 is removed, the orifice OR is not disposed on the first recirculation line 36, and the recirculated hydraulic pressure of the high-pressure regulator valve 22 is supplied entirely to the first low-pressure line 30 in the system of FIG. 9.

As shown in FIG. 9, since the hydraulic pressure of the third recirculation line 42 is low, the switch valve 24 connects the second discharge line 202d with the circulation line 32 by the elastic force of the elastic member 40 at the full discharge mode.

In this case, the hydraulic pressure generated at the first and second pump chambers 201 and 202 is supplied entirely to the high pressure portion HP through the first and second discharge lines 201d 202d and the high-pressure line 28.

As shown in FIG. 10, since the hydraulic pressure of the third recirculation line 42 is high, the switch valve 24 connects the second discharge line 202d with the first low-pressure line 30 at the half discharge mode.

Therefore, the hydraulic pressure generated at the first pump chamber 201 is supplied to the high pressure portion HP through the first discharge line 201d and the high-pressure line 28, and the hydraulic pressure generated at the second pump chamber 202 is supplied to the low-pressure regulator valve 24 through the second discharge line 202d, the switch valve 24, and the first low-pressure line 30. The hydraulic pressure supplied to the low-pressure regulator valve 24 is supplied to the low pressure portion LP through the second low-pressure line 38.

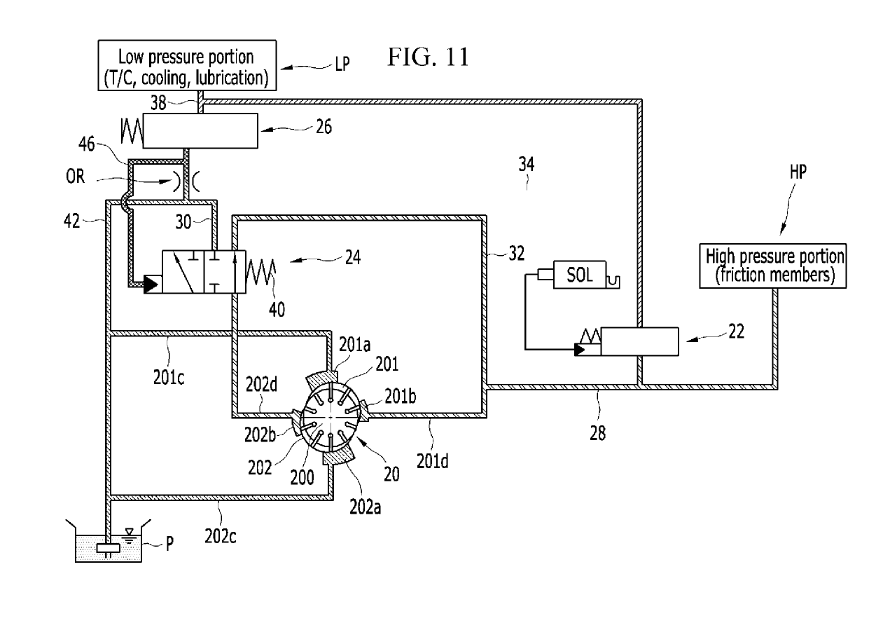

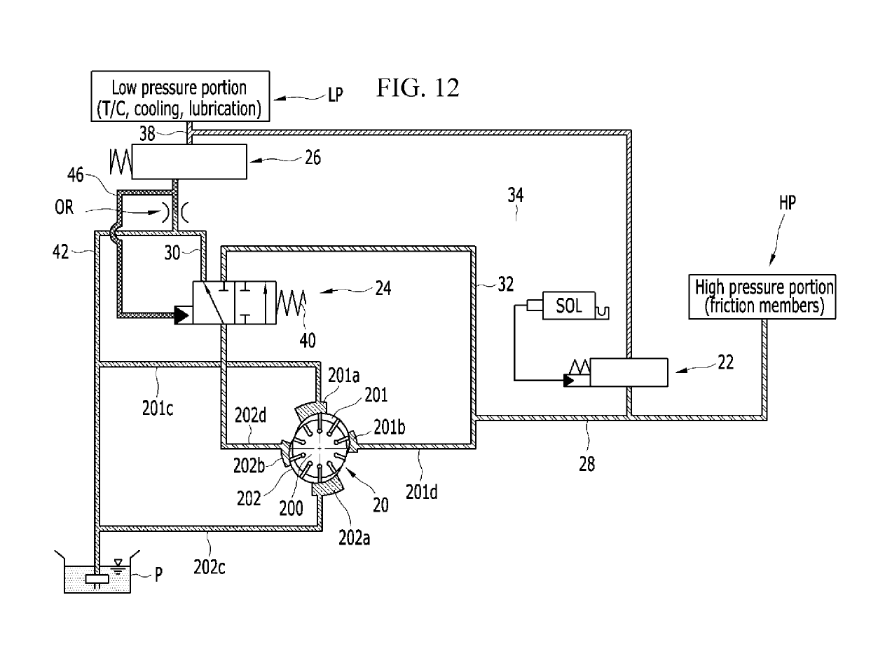

FIG. 11 and FIG. 12 are schematic diagram of a hydraulic pressure supply system according to various embodiments of the present invention. FIG. 11 illustrates oil flow at a full discharge mode, and FIG. 12 illustrates oil flow at a half discharge mode.

Referring to FIG. 11 and FIG. 12, a downstream portion of the first recirculation line 36 is connected to the first low-pressure line 30 in an above-described embodiment, but the downstream of the first recirculation line 36 is connected to the second low-pressure line 38 in various embodiments.

Since functions of system of FIG. 11 are the same as those of FIG. 9 except connection of the first recirculation line 36 to the low-pressure line, detailed description thereof will be omitted.

According to various embodiments of the present invention, the hydraulic pressure generated at the first and second pump chambers of the hydraulic pump is supplied entirely to the high pressure portion at the full discharge mode, and the hydraulic pressure generated at the first pump chamber is supplied to the high pressure portion and the hydraulic pressure generated at the second pump chamber is supplied to the low pressure portion at the half discharge mode.

Therefore, oil amount supplied to the low pressure portion is increased at the half discharge mode. Since oil amount required at the high pressure portion is reduced, the rotation speed for entering the half discharge mode may be lowered and fuel economy may be enhanced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hydraulic pressure supply system of an automatic transmission for a vehicle comprising:
a hydraulic pump provided with first and second pump chambers formed therein and discharging hydraulic pressure generated at the first and second pump chambers;
a high-pressure line supplying the hydraulic pressure discharged from the first pump chamber to a high pressure portion;
a switch valve selectively supplying the hydraulic pressure discharged from the second pump chamber to the high-pressure line or a first low-pressure line;
a low-pressure regulator valve regulating the hydraulic pressure supplied from the first low-pressure line to be stable and supplying the regulated hydraulic pressure to a low pressure portion through a second low-pressure line;
a high-pressure regulator valve regulating the hydraulic pressure supplied to the high-pressure line to be stable and supplying the regulated hydraulic pressure to the high pressure portion; and
a first recirculation line supplying recirculated hydraulic pressure of the high-pressure regulator valve to the low pressure portion.

2. The hydraulic pressure supply system of claim 1, wherein the high-pressure regulator valve is controlled by control pressure of a solenoid valve and elastic force of an elastic member counteracting against the control pressure.

3. The hydraulic pressure supply system of claim 1, wherein the switch valve is controlled by the recirculated hydraulic pressure of the high-pressure regulator valve supplied through a second recirculation line bifurcated from the first recirculation line and elastic force of an elastic member counteracting against the recirculated hydraulic pressure.

4. The hydraulic pressure supply system of claim 2, wherein an orifice is disposed on the first recirculation line downstream of a bifurcating point of the second recirculation line.

5. The hydraulic pressure supply system of claim 2, wherein the switch valve is controlled by the control pressure of the solenoid valve controlling the high-pressure regulator valve and elastic force of an elastic member counteracting against the control pressure.

6. The hydraulic pressure supply system of claim 1, wherein a portion of the hydraulic pressure of the low-pressure regulator valve is recirculated to the first and second pump chambers through a third recirculation line.

7. The hydraulic pressure supply system of claim 6, wherein the switch valve is controlled by hydraulic pressure of a control pressure line bifurcated from the third recirculation line and elastic force of an elastic member counteracting against the hydraulic pressure.

8. The hydraulic pressure supply system of claim 7, wherein an orifice is mounted on the third recirculation line downstream of the bifurcating point of the control pressure line.

9. The hydraulic pressure supply system of claim 1, wherein the first recirculation line is connected to a low-pressure line between the switch valve and the low-pressure regulator valve.

10. The hydraulic pressure supply system of claim 4, further comprising a bypass line connecting the first recirculation line downstream of the orifice with the high-pressure regulator valve.

11. The hydraulic pressure supply system of claim 1, wherein the first recirculation line is connected to a low-pressure line between the low-pressure regulator valve and the low pressure portion.

12. A hydraulic pressure supply system of an automatic transmission for a vehicle comprising:
first and second pump chambers, wherein system selectively supplies hydraulic pressure generated at the first and second pump chambers to a high pressure portion or the high pressure portion and a low pressure portion;
wherein the hydraulic pressure generated at the first pump chamber is supplied to the high pressure portion through a high-pressure regulator valve, and the hydraulic pressure generated at the second pump chamber is supplied to the low pressure portion through a low-pressure regulator valve or is supplied to the high-pressure regulator valve according to switching operation of a switch valve; and
wherein recirculated hydraulic pressure of the high-pressure regulator valve is additionally supplied to the low pressure portion.

13. The hydraulic pressure supply system of claim 12, wherein a portion of the recirculated hydraulic pressure of the high-pressure regulator valve is reduced by an orifice and is then supplied to the low pressure portion.

14. The hydraulic pressure supply system of claim 12, wherein a portion of the recirculated hydraulic pressure of the high-pressure regulator valve is supplied to the switch valve as control pressure.

15. The hydraulic pressure supply system of claim 12, wherein the high-pressure regulator valve is controlled by control pressure of a solenoid valve.

16. The hydraulic pressure supply system of claim 15, wherein the switch valve is controlled by the control pressure of the solenoid valve.

17. The hydraulic pressure supply system of claim 12, wherein recirculated hydraulic pressure of the low-pressure regulator valve is recirculated to the first and second pump chambers.

18. The hydraulic pressure supply system of claim 17, wherein a portion of the recirculated hydraulic pressure of the low-pressure regulator valve is supplied to the switch valve as control pressure.

19. The hydraulic pressure supply system of claim 12, wherein the recirculated hydraulic pressure of the high-pressure regulator valve is supplied between the switch valve and the low-pressure regulator valve.

20. The hydraulic pressure supply system of claim 12, wherein the recirculated hydraulic pressure of the high-pressure regulator valve is supplied between the low-pressure regulator valve and the low pressure portion.
